(19) United States
(12) Patent Application Publication
(10) Pub. No.: US 2025/0360883 A1
(43) Pub. Date: Nov. 27, 2025

(54) EXTERIOR PANEL

(71) Applicant: TOYODA GOSEI CO., LTD., Kiyosu-shi (JP)

(72) Inventors: Kazuhisa TAKAHASHI, Kiyosu-shi (JP); Jun YAMAGUCHI, Kiyosu-shi (JP); Koji FUKAGAWA, Kiyosu-shi (JP); Koji OKUMURA, Kiyosu-shi (JP); Yuhki KURAMITSU, Kiyosu-shi (JP)

(21) Appl. No.: 19/173,396

(22) Filed: Apr. 8, 2025

(30) Foreign Application Priority Data
May 23, 2024 (JP) 2024-084096

(51) Int. Cl. B60R 13/04

(52) U.S. Cl. CPC B60R 13/04

(57) ABSTRACT

An exterior panel includes a panel body including a first ornamental surface and a recess, and a cover member, including an ornamental wall that covers an open portion of the recess. The recess includes a peripheral wall and a bottom wall. The cover member includes the ornamental wall, an abutment wall that abuts the bottom wall, and a connection wall that connects with an edge of the abutment wall and an inner surface of the ornamental wall. The peripheral wall includes the inner surface on which positioning ribs are arranged. The positioning ribs extend in a first direction. The inner edge of the open portion includes an inclined portion that is inclined to widen the open portion as the first ornamental surface becomes closer in the first direction. An outer edge of the ornamental wall is in contact with the inclined portion.

### CROSS-REFERENCE TO RELATED APPLICATIONS

This application is based upon and claims the benefit of priority from Japanese Patent Application No. 2024-084096, filed on May 23, 2024, the entire contents of which are incorporated herein by reference.

### BACKGROUND

### 1. Field

The following description relates to an exterior panel configured to form at least part of an exterior body of a mobile unit.

### 2. Description of Related Art

Japanese Laid-Open Patent Publication No. 2001-294105 discloses an automobile exterior component (hereafter referred to as exterior component). The exterior component disclosed in the above publication includes a main body, which has an open portion, and a cover, which is attached to the open portion to close the open portion. A flange extends from the open portion of the main body along the inner edge of the open portion. The cover includes a cover body and an engagement portion that projects outward from the cover body and engages the flange. The engagement portion includes a leg with hooked portion that is engageable with a flat tool.

The exterior component disclosed in the above publication has a shortcoming in that, a gap may be formed between the inner edge of the open portion and the outer edge of the cover, and in that a step may be formed between the ornamental surface of the main body and the ornamental surface of the cover.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an exterior panel configured to form at least a part of an exterior body of a mobile unit includes a panel body including a first ornamental surface and a recess that opens in the first ornamental surface. The exterior panel also includes a cover member. The cover member includes an ornamental wall that is inserted into the recess to cover an open portion of the recess. The cover member also includes a second ornamental surface. The first ornamental surface and the second ornamental surface form an ornamental surface of the exterior panel. The recess includes a peripheral wall connected to an inner edge of the open portion, and a bottom wall connected to the peripheral wall. The cover member includes the ornamental wall, an abutment wall that abuts the bottom wall, and a connection wall that connects an edge of the abutment wall and an inner surface of the ornamental wall. The peripheral wall includes an inner surface on which positioning ribs are arranged at intervals around the recess. The positioning ribs contact an outer surface of the connection wall and extend in a first direction, in which the cover member is inserted into the recess. The inner edge of the open portion includes an inclined portion that is inclined to widen the open portion as the first ornamental surface becomes closer in the first direction. An outer edge of the ornamental wall is in contact with the inclined portion.

Other features and aspects will be apparent from the following detailed description, the drawings, and the claims.

### BRIEF DESCRIPTION OF THE DRAWINGS

FIG. 1 is an exploded front perspective view of an exterior panel in accordance with one embodiment.

FIG. 2 is an enlarged perspective view focusing on a recess of a panel body shown in FIG. 1.

FIG. 3 is a rear perspective view of a cover member shown in FIG. 1.

FIG. 4A is a cross-sectional view of the exterior panel taken along line 4-4 in FIG. 2.

FIG. 4B is an enlarged cross-sectional view showing part of FIG. 4A.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment of an exterior panel 10 forming part of a front exterior body of an automobile will now be described, with reference to the drawings.

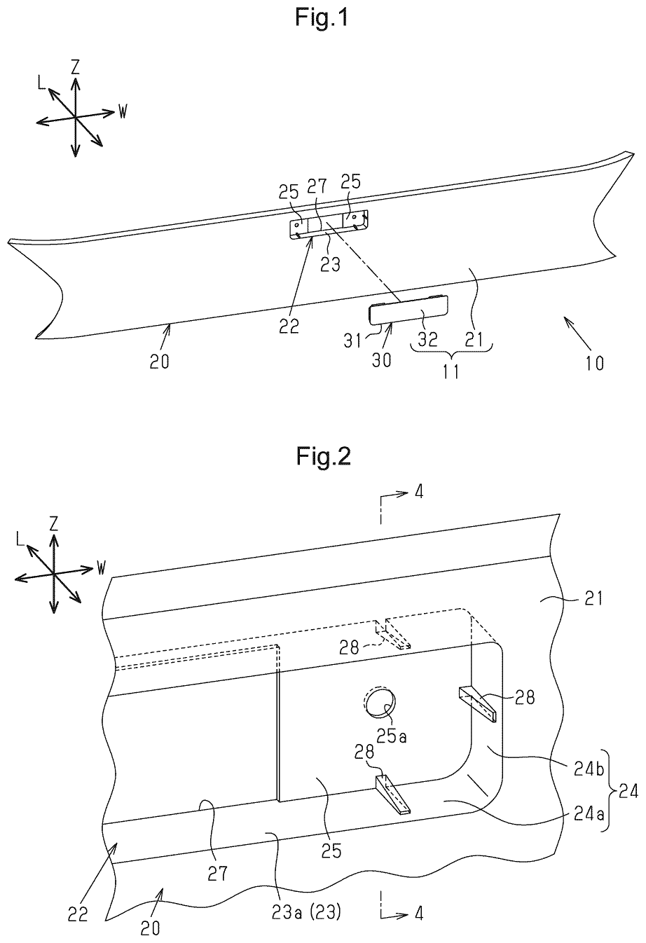

As shown in FIG. 1, the exterior panel 10 includes a panel body 20 and a cover member 30. The panel body 20 includes a first ornamental surface 21, and a recess 22, which opens in the first ornamental surface 21. The cover member 30 includes an ornamental wall 31.

The ornamental wall 31 includes a second ornamental surface 32. The ornamental wall 31 is inserted into the recess 22, to cover an open portion 23 of the recess 22. The first ornamental surface 21 of the panel body 20 and the second ornamental surface 32 of the cover member 30 form an ornamental surface 11 of the exterior panel 10.

In the description hereafter, the direction in which the cover member 30 is inserted into the recess 22 is referred to as the first direction L. In the present embodiment, the first direction L corresponds to a front-rear direction of the automobile. A second direction W, which is orthogonal to the first direction L, corresponds to an automobile width direction. Further, a third direction Z, which is orthogonal to both the first direction L and the second direction W, corresponds to a vertical direction of the automobile.

### Panel Body 20

As shown in FIG. 1, the panel body 20 extends in the second direction W and the third direction Z. The recess 22 of the present embodiment is substantially rectangular in front view and has long sides extending in the second direction W. The recess 22 is located in the central part of the panel body 20 with respect to the second direction W.

As shown in FIG. 2, the recess 22 includes a peripheral wall 24 and a bottom wall 25. The peripheral wall 24 is connected to an inner edge 23a of the open portion 23, and the bottom wall 25 is connected to the peripheral wall 24.

In the present embodiment, two bottom walls 25 are spaced apart from each other in the second direction W. A through hole 27 extends between the two bottom walls 25. The bottom walls 25 are each substantially rectangular in front view and each includes an insertion hole 25a for insertion of a screw 50. The through hole 27 is substantially rectangular in front view.

The peripheral wall 24 of the present embodiment includes two side lateral wall portions 24a extending along the second direction W. Further, the peripheral wall 24 includes two vertical wall portions 24b extending in the third direction Z.

Positioning ribs 28 extend along the peripheral wall 24 in the first direction L. The positioning ribs 28 are arranged at intervals around the peripheral wall 24. The projection amount of each positioning rib 28 increases toward the bottom wall 25 in the first direction of L.

In the present embodiment, one positioning rib 28 is arranged between one of the two lateral wall portions 24a and the bottom wall 25. The positioning rib 28 is located at the central part of the lateral wall portion 24a in the second direction W.

One positioning rib 28 is arranged on the vertical wall portion 24b of the peripheral wall 24. The positioning rib 28 is located at the central part of the vertical wall portion 24b with respect to the third direction Z.

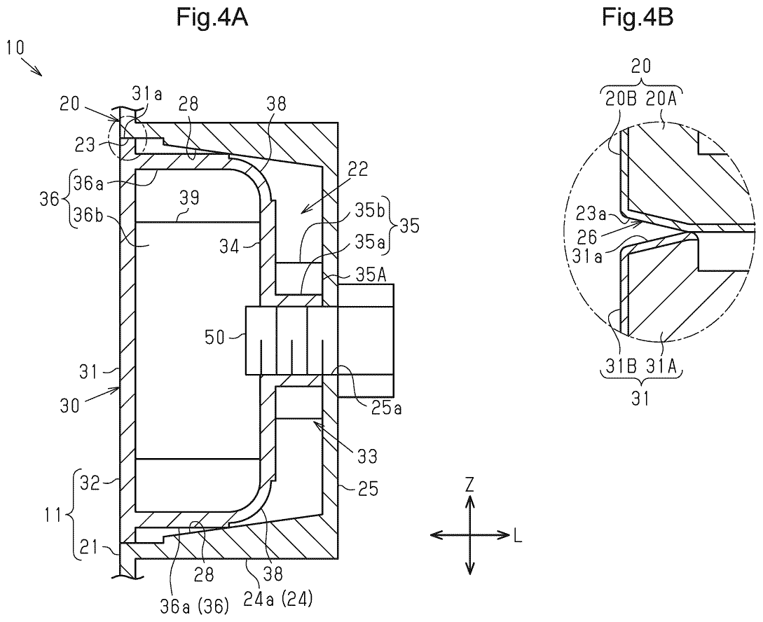

As shown in FIG. 4B, the inner edge 23a of the open portion 23 includes an inclined portion 26. The inclined portion 26 is inclined to widen the open portion 23 as the ornamental surface 21 becomes closer in the first direction L. The inclined portion 26 is formed along the entire inner edge 23a of the open portion 23.

Preferably, the inclined portion 26 is inclined relative to a hypothetical axis extending in the first direction L, at an angle from 1.5 to 4.5 degrees. The inclination angle of the inclined portion 26 in the present embodiment is set to 3 degrees.

The panel body 20 includes a base 20A and a coating 20B which is applied to the outer surface of the base 20A. The base 20A is formed from a known synthetic resin. The coating 20B is formed from a known synthetic resin.

Moreover, the panel body 20 of the present embodiment is impermeable to electromagnetic waves.

### Cover Member 30

As shown in FIG. 1, the cover member 30 includes the ornamental wall 31, abutment walls 33, and connection walls 36.

The ornamental wall 31 has the same substantially rectangular shape as the open portion 23 in front view.

As shown in FIG. 4B, an outer edge 31a of the ornamental wall 31, is in contact with the inclined portion 26 of the inner edge 23a in the open portion 23. The outer edge 31a of the ornamental wall 31 in the present embodiment, is inclined so as to narrow the ornamental wall 31, as the second ornamental surface 32 becomes closer in the first direction L.

Preferably, the outer edge 31a is inclined relative to the hypothetical axis, which extends in the first direction L, at an angle from 1.5 to 4.5 degrees. The inclination angle of the outer edge 31a of the present embodiment is set to 3 degrees.

The ornamental wall 31 is permeable to electromagnetic waves. The ornamental wall 31 includes base 31A, which is permeable to electronic waves, and coating 31B, which is permeable to electronic waves and applied to the outer surface of the base 31A. The base 31A is formed from a known synthetic resin. The coating 31B is formed from a known synthetic resin.

In the present embodiment, a clearance of 0 to 0.2 mm is set between the outer edge 31a of the ornamental wall 31 and the inner edge 23a of the open portion 23; more specifically, between the base 20A of the panel body 20 and the base 31A of the ornamental wall 31. Further, the coating 20B of the panel body 20 and the coating 31B of the ornamental wall 31 each have a thickness of 0.2 mm. Thus, the coating 20B and 31B slightly interfere with each other.

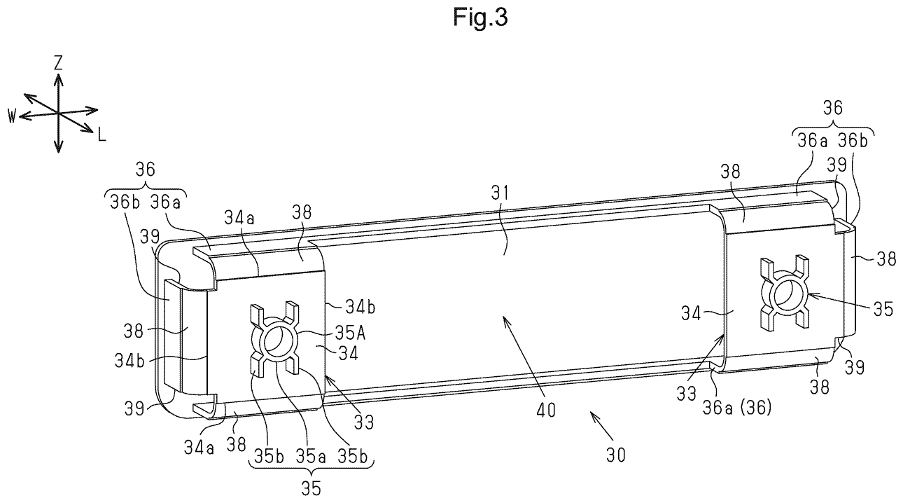

As shown in FIG. 3, in the present embodiment, two abutment walls of 33 are spaced apart from each other in the second direction W.

As shown in FIGS. 3 and 4A, each abutment wall 33 includes an abutment wall body 34 and a projection 35, which projects from the abutment wall body 34 toward the bottom wall 25. The projection 35 includes an abutment surface 35A which abuts the bottom wall 25.

The abutment wall body 34 is rectangular and includes two first sides 34a and two second sides 34b. The first sides 34a extend in the second direction W. The second sides 34b extend in the third direction Z.

The projection 35 includes a tubular portion 35a through which the screw 50 is inserted. The tubular portion 35a includes an axis that extends in the first direction L. The projection 35 includes extensions 35b, which extend outward from the tubular portion 35a. In the present embodiment, four extensions of 35b are arranged at intervals in the circumferential direction of the tubular portion 35a. The tubular portion 35a and the extensions 35b both include the abutment surface 35A. Each of the extensions 35b includes a portion extending from the tubular portion 35a in the radial direction of the tubular portion 35a, and a portion bent from the radially extending portion and extending in the third direction Z.

An open space 40 extends between the two abutment walls 33 over the through hole 27 of the panel body 20 in the first direction L.

The connection walls 36 connect the edges of the abutment walls 33 and the inner surface of the ornamental wall 31. The connection walls 36 extend in the first direction L.

The connection walls 36 each include first side walls 36a, which correspond to the first sides 34a of the abutment wall body 34, and a second side wall 36b, which corresponds to one of the second sides 34b of the abutment wall body 34. In other words, the first side walls 36a extend in the second direction W. The second side wall 36b extends in the third direction Z.

The connection wall 36 is connected to the corresponding abutment wall 33 by connecting portions 38.

The connecting portions 38 have higher flexibility than the abutment wall 33 and the connection wall 36. The connecting portions 38 are curved inwardly toward the abutment wall 33 with respect to the first direction L. The connecting portions 38 connected to the first side walls 36a have the same radius of curvature as the connecting portion 38 connected to the second side wall 36b. The preferable radius of curvature of the connecting portion 38 is at least 3 mm and at most 15 mm.

The connecting portions 38 are thinner than the abutment wall body 34 and the connection wall 36. The connecting portions 38 connected to the first side walls 36a and the connecting portion 38 connected to the second side wall 36b have the same thickness. Moreover, in the present embodiment, the abutment wall body 34 has the same thickness as the connection wall 36.

The connection wall 36 includes notches 39, each located at the corner between each first side walls 36a and the second side wall 36b. In the present embodiment, the notches 39 are formed by cutting out the connection wall 36 and the connecting portions 38 in the third direction Z. Moreover, the notches 39 are formed by cutting the corners of the abutment wall body 34.

As shown in FIG. 4A, the outer surface of the connection wall 36 of the cover member 30 is in contact with the corresponding positioning ribs 28 of the panel body 20.

The operation of the present embodiment will now be described.

When the cover member 30 is inserted into the recess 22 of the panel body 20, the positioning ribs 28, which are arranged on the inner surface of the peripheral wall 24 in the recess 22, slightly interfere with the outer surfaces of the connection walls 36 of the cover member 30. This positions the cover member 30 on the ornamental surface 11 of the exterior panel 10 in a planar direction. Furthermore, the abutment surface 35A of each projection 35 on the abutment walls 33 of the cover member 30 abuts the bottom wall 25 of the recess 22. This positions the cover member 30 in the first direction L. As a result, the cover member 30 is readily inserted into the recess 22 of the panel body 20 at the specified position. This avoids the formation of a step between the first ornamental surface 21 and the second ornamental surface 32.

Further, the inclined portion 26 of the inner edge 23a of the open portion 23 is inclined to widen the open portion 23 as the ornamental surface 21 becomes closer in the first direction L. Therefore, when the cover member 30 is inserted into the recess 22 of the panel body 20, the outer edge 31a of the ornamental wall 31 of the cover member 30 contacts and slightly interferes with the inclined portion 26. As a result, a gap between the inner edge 23a of the recess 22 and the outer edge 31a of the ornamental wall 31 will not be formed.

The advantages of the present embodiment will now be described.

(1) The positioning ribs 28 are arranged on the inner surface of the peripheral wall 24 at intervals around the recess 22. The positioning ribs 28 extend in the direction L, which is the direction in which the cover member 30 is inserted into the recess 22, and contact the outer surfaces of the connection walls 36. The inner edge 23a of the open portion 23 is inclined to widen the open portion 23 as the first ornamental surface 21 becomes closer in the first direction L. The outer edge 31a of the ornamental wall 31 contacts the inclined portion 26.

This structure improves the exterior appearance of the exterior panel 10.

(2) The connection wall 36 extends in the first direction L. The connection wall 36 and the abutment wall 33 are connected by the connecting portions 38. The connecting portions 38 have higher flexibility than the abutment wall 33 and the connection wall 36.

When the cover member 30 is inserted into the recess 22 of the panel body 20 in a state tilted from the proper position, load may act on the connection walls 36 and deform the connection walls 36. This may form a step between the first ornamental surface 21 and the second ornamental surface 32 or form a gap between the inner edge 23a of the open portion 23 and the outer edge 31a of the ornamental wall 31.

In this respect, in the above structure, when load acts on the connection walls 36, the connecting portions 38 will deform before the connection walls 36 deform. This limits the deformation of the connection walls 36. Therefore, a step between the first ornamental surface 21 and the second ornamental surface 32 will not form since deformation of the connection walls 36 will not occur. Further, a gap will not form between the inner edge 23a of the open portion 23 and the outer edge 31a of the ornamental wall 31 since deformation of the connection walls 36 will not occur.

(3) The curved shape of the connecting portions 38 allows the connecting portions 38 to have higher flexibility than the abutment wall 33 and the connection walls 36. In particular, the connecting portions 38 have the same radius of curvature and thereby further limit the deformation of the connection walls 36.

(4) The connecting portions 38 are thinner than the abutment wall 33 and the connection walls 36. This readily allows the connecting portion 38 to have higher flexibility than the abutment wall 33 and the connection walls 36.

(5) Each abutment wall 33 is rectangular and includes two first sides 34a and two second sides 34b. The corresponding connection wall 36 includes the notches 39 at the corners between the first side walls 36a, which correspond to the first sides 34a, and the second side wall 36b, which corresponds to one of the second sides 34b.

With this structure, the notches 39 allow the connection wall 36 to deform more readily than when there are no notches 39. Consequently, the deformation of the connection wall 36 allows the dimensional differences of the cover member 30 to be absorbed. The absorption of dimensional differences will limit the formation of a step between the first ornamental surface 21 and the second ornamental surface 32, and the formation of a gap between the inner edge 23a of the open portion 23 and the outer edge 31a of the ornamental wall 31.

(6) Each projection 35, which projects from the abutment wall body 34 of the abutment wall 33, includes the abutment surface 35A. This allows the cover member 30 to be smaller in size than when the abutment wall 33 does not include the projection 35 and the abutment wall body 34 abuts the bottom wall 25 of the recess 22.

(7) Each bottom wall 25 includes the insertion hole 25a for insertion of the screw 50. The corresponding projection 35 includes the tubular portion 35a for insertion of the screw 50.

With this structure, the insertion of the screw 50 through the insertion hole 25a of the bottom wall 25 and the tubular portion 35a of the projection 35 allows the abutment wall 33 of the cover member 30 to be firmly fixed to the bottom wall 25 of the recess 22.

(8) Each projection 35 includes the tubular portion 35a and the extensions 35b. Although the area of contact is small between the tubular portion 35a and the bottom wall 25, the area of contact between the extensions 35b and the bottom wall 25 ensures sufficient area for the abutment surface 35A of the projection 35. This avoids a situation in which the cover member 30 is coupled to the recess 22 of the panel body 20 in a state tilted from the proper position.

(9) The ornamental wall 31 is permeable to electromagnetic waves. Therefore, the exterior panel 10 can be applied as an exterior panel that covers an electromagnetic wave radar device (not shown) and is permeable to electromagnetic waves.

(10) The two bottom walls 25 are spaced apart from each other in the second direction W, which is orthogonal to the first direction L. The two abutment walls 33 are spaced apart from each other in the second direction W. The through hole 27 extends over the open space 40 in the first direction L. The through-hole 27 is between the two bottom walls 25 and the open space 40 is between the two abutment walls 33.

With this structure, electromagnetic waves passing through the through hole 27 of the panel body 20 and the open space 40 of the cover member 30 are transmitted through the ornamental wall 31 of the cover member 30. Therefore, electromagnetic waves are transmitted through only the ornamental wall 31 of the exterior panel 10. This improves electromagnetic wave transmittivity of the exterior panel 10.

(11) The ornamental wall 31 includes the base 31A, which is permeable to electromagnetic waves, and the coating 31B, which is permeable to electromagnetic waves and applied to the outer surface of the base 31A. This increases the degree of freedom in the outer appearance of the second ornamental surface 32, which in turn, increases the degree of freedom in the ornamental surface 11 of the panel body 20.

### Modifications

The above-described embodiment may be modified as follows. The above-described embodiment and the following modifications can be combined as long as the combined modifications remain technically consistent with each other.

The ornamental wall 31 may include only the base 31A. In this case, the base 31A forms the second ornamental surface 32.

In the above-described embodiment, the panel body 20 includes two bottom walls 25. However, the panel body 20 may include only one bottom wall 25. In this case, the bottom wall 25 should be permeable to electromagnetic waves.

A heater, which is heated when energized, may be arranged on the ornamental wall 31. In this case, the heat of the heater melts ice and snow on the ornamental wall 31.

The exterior panel 10 is not limited to a panel that covers the electromagnetic wave radar. Thus, the ornamental wall 31 may be impermeable to electromagnetic waves.

The extensions 35b may be changed in number, shape, and size.

The extensions 35b of the projection 35 may be omitted.

The cover member 30 does not have to be fixed to the panel body 20 by the screws 50, and the screws 50 may be omitted. In this case, the insertion hole 25a may be omitted from each bottom wall 25. Furthermore, the tubular portion 35a may be omitted from each projection 35.

The projection 35 may be omitted from each abutment wall 33. In this case, the abutment wall body 34 may abut the bottom wall 25.

The notches 39 may be omitted from the connection walls 36 of the cover member 30.

The connecting portion 38 may have the same thickness as the abutment wall body 34 and the connection wall 36.

The connecting portion 38 does not need to be curved. In other words, the connecting portion 38 does not need to be more flexible than the abutment wall body 34 and the connection wall 36.

The above-described embodiment exemplifies a structure in which the outer edge 31a of the ornamental wall 31 is inclined so that the ornamental wall 31 narrows as the second ornamental surface 32 becomes closer in the first direction L. This, however is not a limitation. For example, the outer edge 31a of the ornamental wall 31 may extend in the first direction L.

The positioning ribs 28 may be changed in number, shape, and size. For example, if the recess 22 is round in a front view, at least three positioning ribs may be arranged at intervals in the circumferential direction. Moreover, if the recess 22 is rectangular in a front view, at least four positioning ribs may be arranged at intervals around the recess 22.

In the above-described embodiment, the positioning ribs 28 may be omitted from the two lateral wall portions 24a. In this case, the positioning ribs 28 arranged on the two vertical wall portions 24b position the cover member 30 in the second direction W.

In the above-described embodiment, the positioning ribs 28 may be omitted from the two vertical wall portions 24b. In this case, the positioning ribs 28 arranged on the two lateral wall portions 24a position the cover member 30 in the third direction Z.

The inclined portion 26 does not need to be arranged along the entire inner edge 23a of the open portion 23. That is, the inclined portion 26 may be omitted from part of the inner edge 23a of the open portion 23.

The above-described embodiment exemplifies a structure in which the exterior panel 10 forms part of the front exterior body of the automobile. However, the exterior panel is not limited in such a manner. For example, the exterior panel may form part of the rear exterior body of the automobile. Further, the exterior panel may be applied to a mobile unit other than an automobile. For example, the exterior panel may be applied to a vehicle other than an automobile.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An exterior panel configured to form at least a part of an exterior body of a mobile unit, the exterior panel comprising:
a panel body including a first ornamental surface and a recess that opens in the first ornamental surface; and
a cover member including an ornamental wall that is inserted into the recess to cover an open portion of the recess, the ornamental wall including a second ornamental surface, wherein,
the first ornamental surface and the second ornamental surface form an ornamental surface of the exterior panel,
the recess includes a peripheral wall connected to an inner edge of the open portion, and a bottom wall connected to the peripheral wall,
the cover member includes the ornamental wall, an abutment wall that abuts the bottom wall, and a connection wall that connects an edge of the abutment wall and an inner surface of the ornamental wall,
the peripheral wall includes an inner surface on which positioning ribs are arranged at intervals around the recess, the positioning ribs contacting an outer surface of the connection wall and extending in a first direction, in which the cover member is inserted into the recess,
the inner edge of the open portion includes an inclined portion that is inclined to widen the open portion as the first ornamental surface becomes closer in the first direction, and
an outer edge of the ornamental wall is in contact with the inclined portion.

2. The exterior panel according to claim 1, wherein
the connection wall extends in the first direction,
the connection wall and the abutment wall are connected by a connection portion, and
the connecting portion has higher flexibility than the abutment wall and the connection wall.

3. The exterior panel according to claim 2, wherein
the connecting portion is curved inwardly toward the abutment wall with respect to the first direction.

4. The exterior panel according to claim 2, wherein
the connecting portion is thinner than the abutment wall and the connection wall.

5. The exterior panel according to claim 1, wherein
the abutment wall is rectangular and includes two first sides and two second sides, and
the connection wall includes a first side wall corresponding to one of the first sides, a second side wall corresponding to one of the second sides, and a notch at a corner between the first side wall and the second side wall.

6. The exterior panel according to claim 1, wherein
the abutment wall includes an abutment wall body and a projection projecting from the abutment wall body toward the bottom wall, and
the projection includes an abutment surface that abuts the bottom wall.

7. The exterior panel according to claim 6, wherein
the bottom wall includes an insertion hole for insertion of a screw, and
the projection includes a tubular portion for insertion of the screw.

8. The exterior panel according to claim 7, wherein
the projection includes extensions extending outward from the tubular portion, and
the tubular portion and the extensions both include the abutment surface.

9. The exterior panel according to claim 1, wherein
the ornamental wall is permeable to electromagnetic waves.

10. The exterior panel according to claim 9, wherein
the bottom wall is one of two bottom walls spaced apart from each other in a second direction that is orthogonal to the first direction,
the abutment wall is one of two abutment walls spaced apart from each other in the second direction, and
a through hole between the two bottom walls, and an open space between the two abutment walls extend over each other in the first direction.

11. The exterior panel according to claim 9, wherein
the ornamental wall includes a base permeable to electronic waves, and a coating permeable to electronic waves and applied to an outer surface of the base.
